(19) United States
(12) Patent Application Publication
(10) Pub. No.: US 2015/0232638 A1
(43) Pub. Date: Aug. 20, 2015

(54) MASS BASED ON GAUGED SAND AND ELASTIC BINDER

(71) Applicant: João Policarpo ROQUETTE PINHEIRO DE MELO, Faro (PT)

(72) Inventor: João Policarpo Roquette Pinheiro De Melo, Faro (PT)

(21) Appl. No.: 14/430,535

(22) PCT Filed: Sep. 23, 2013
(86) PCT No.: PCT/PT2013/000056

§ 371 Date: Mar. 23, 2015

(30) Foreign Application Priority Data
Sep. 25, 2012 (PT) 10920

(51) Int. Cl. C08K 3/36; C08K 5/01; C08J 3/20; E02D 3/12

(52) U.S. Cl. CPC C08K 3/36; E02D 3/126; C08K 5/01; C08J 3/203; C08J 2383/00

(57) ABSTRACT

The present invention relates to a mass based on calibrated sand and elastic binder, and relates to the field of the industry of construction, more precisely dredging works, and coastline protection and/or sand movements. The present invention relates to a construction material based on calibrated sand and elastic binder which includes, for a plaque 50 cm in width, 75 cm in length and 1.5 cm thick, the following components: between 5000 g to 6500 g of calibrated sand, between 200 g to 360 g of silicone and between 0.4 l to 0.6 l turpentine. The invention refers also to a process for obtaining the above-mentioned material, including the following steps: the sand is blended with the mixture of silicone, liquefied and/or diluted with turpentine, the mixture is introduced in the desired mold for the intended shape, and, through the use of vibration and compaction of the mold the desired consistency is obtained.

### TECHNICAL FIELD

The present invention relates to the field of construction industry, more precisely to the field of dredging works, coastline protection and/or sand movements. According to the invention a mass based on calibrated sand and agglomerated is designed, by means of an elastic binder.

The present invention is designed to the use and transformation of sand (of the beach kind) for new products and sub-products.

By means of the sand and the mixture with the discovered binder, a material was created which is manufactured by means of a correct mixture, of vibration in its moulding process and also in the compression, to obtain a final material with resistance capacities to vibration, chock and bad weather, as well as to wear caused by time and able to resist to different temperatures.

### BACKGROUND OF THE INVENTION

There are several construction materials in this field that, due to their similarity, could solve some of the problems that the building and dredging industry proposes to solve with this material.

The European Patent EP0786325 relates to a method and apparatus for the production of slabs of granulated stone materials, granulates and/or sands bound to a hardenable resin, but it doesn't solve the problem of malleability, creating a rigid but not flexible material, with a very high manufacturing cost, and the components are also quite different.

The Patent US2012/0190774A1 relates to a composition for the production of a lime sand brick, with different components, and to a method to manufacture the same, which takes place under pressure of saturated steam.

The Patent CN1487054 relates to sand-fixing polymer-cement material, a mixture of cement, rich in sand, together with a fixation resin, in order to be sprayed, creating a kind of mesh, which could sustain the sand movements.

The Patent KR20020072397 A relates to a kind of thick varnish coating for construction finishing work with electro-conductive capabilities that also works as an electric absorbent, and has no relation with this application.

The Patent GB191101637 relates to a tile copy system, that's to say, a method for copying tiles into plaques, in order to replace a copy in places where the degradation is substantial.

These patents, among others, refer usually to hard and non-flexible products, with quite high process and manufacture costs, whose components also differ and do not solve the technical problem set, some of which have quite distinct aims and completely different purposes.

The present invention is based on the high use of the sand, since, in the above mentioned industries, this natural material is under-valued and we can solve several problems with this application, through the numerous possible applications, providing a finishing that is as natural as possible.

### SUMMARY OF THE INVENTION

The object of the present invention is to use an extremely abundant material, such as sand, at highly competitive values, obtaining an industrial material, in a simple, easy and ecological way.

This new material is composed and based on calibrated sand and elastic binder.

The process for the preparation of the referred mass is also described.

### DETAILED DESCRIPTION OF THE INVENTION

The applicant has conducted an investigation in order to obtain a material which could solve the adaptability problems to several types of construction and which combines resistance, flexibility, capacity of insulation, chock resistance, natural appearance, among other necessary features, all this with a low manufacturing cost.

He began to realize that the use of sand could have a different and more productive purpose.

At first a technical problem arose relating to the mixture of the sand in a mass with strong consistency, resistance, malleability, insulating and which, at the same time, presented a low production cost.

After several attempts, using different compositions, he assayed a still very fragile mass, with extremely high costs of manufacture, but always assuming that the use of sand would always seem logical and most appropriate in these industries, due to its traditional usage and also its natural abundance and easy location.

After several prototypes and experiences, the applicant surprisingly found that, if one of the components was diluted, the mixture could be improved and achieve a better compromise between the used materials.

Here, he faced the problem of being able to dissolve the binder silicone, without loosing its binding capacity.

Several ingredients existing in the market were used, which didn't provide a satisfactory response to this problem, and a few silicone-producing factories were then contacted, but these were not able to solve the question as well.

The silicone should be treated against ultraviolet rays and, preferably, be transparent or white, and this colour does not affect the quality of the material.

All the mixtures performed with a mechanical mixer resulted in masses that did not present the intended characteristics.

As such, the use of an almost natural solvent was tried, and turpentine was the chosen one, which proved that, when used, didn't break the molecular chain and allowed the silicone to dissolve.

However, another solvent can be used, as long as it does not break the silicone molecules and allows keeping the adhesive qualities of the same.

The following steps were finding the correct quantity of the solvent, so that the silicone didn't loose its binding capacity, besides finding the correct quantity of sand, which required several adjustments.

At last it was seen that, through the compaction and vibration during the moulding process, a better result on the final material could be obtained.

It was concluded that, for better results, the mass should have the following principles: dilution of one of its components, compaction of sand after the making of the mixture, and, finally, vibration during the moulding process.

With these three steps, we believe to have found the best process for the manufacture of this material.

Through this process the mass was improved, and if we can apply a separate level to each process (mixture, vibration and compaction in moulding), different qualities of material are obtained, as well as different possible applications.

### OBJECT OF THE INVENTION

It is an object of the present invention a mass based on calibrated sand and an elastic binder, characterized by including, for a plaque of 50 cm×75 cm×1.5 cm thick, between 5.500 Kg to 6.500 Kg of calibrated sand, between 200 g to 360 g of silicone and between 0.4 l to 0.6 l of turpentine.

The used silicone should be resistant to ultraviolet rays. To these components the manufacturing method is added, where the vibration and the compaction and/or hydraulic or mechanical clamping, has a real importance, thus determining the result to be reached.

Therefore, it is a second object of the present invention a process for the preparation of the mass that follows the following steps: the silicone is diluted with turpentine, using a mechanical mixer, of the shaker type, until an homogenous mixture is obtained, and then the calibrated sand is added to the mixture, until all sand has a wet look, and it is seen that the turpentine effect has been spread unilaterally through all the sand, thus obtaining an homogeneous mixture with wet and loosen sand look.

Only after the achievement of this mixture, should the mass be introduced in the desired mould, being the sand vibrated for a better filling of the empty spaces between the grains, and, then the mixture is compacted within the mould through the hydraulic and/or mechanical compaction, which confers a higher or lower resistance level, according to the application intended for the material.

The mass takes around one to three days to reach the desired consistency always depending on the volume involved, and could take longer if the manufactured block has an industrial type thickness.

### PREFERRED EMBODIMENT OF THE INVENTION

For a plate 50 cm width and 75 cm length and 1.5 cm thick, according to the following invention, the following components were used:

a) Calibrated sand—6.100 kg;

b) Silicone—280 g; and

c) Turpentine—0.5 l.

For the manufacturing process of the mass, the following steps should be taken:

a) The silicone is diluted with turpentine, using a mechanical mixer, until a homogeneous mixture is obtained.

b) The calibrated sand is added in separate portions, in order to facilitate its mixture, until a homogeneous mixture with wet and loosen look is obtained.

c) The mixture is introduced in the desired mould for the intended shape.

d) The mixture is vibrated, through a vibrating table, for a better compaction of the material.

e) The mixture is compacted, through tightening by means of a pressing or hydraulic system, during the material drying and curing time.

f) The material takes 1 to 3 days to achieve the desired consistency.

Being a new and mouldable material, the possible applications for the present invention are not yet totally defined and could be various.

However, the development of the same was designed within the dredging industry, so the indicated applications were designed for the protection of shoreline, fluvial clamping blocks, protective river mats, building blocks, road division and protection and protection of sea walls.

The present invention could also be used in the construction industry and in construction in general, such as in bricks, plaques for coatings (with thermal and acoustic insulation properties, anti-seismic properties and fire resistance, waterproofing and anti-ultraviolet), zones of maritime access for recreational crafts, coastline protection blocks, brick type blocks for the construction in general, wall linings (thermal and waterproofing insulation), road and highway divisions, covering screens in areas of dune erosion, tube coverings and oil transportation cables, gas and underwater communications, covering of drainage ditches.

It can also be used for decoration, as well as in playgrounds.

Although the invention has been described in relation to the preferred embodiment, the experts in the field should understand that alterations and modifications could be made to the appended claims, without departing from the scope of the invention.

1-3. (canceled)

4. Mass characterized by being based on calibrated sand and elastic binder.

5. Mass, according to claim 1, wherein it includes the following components, for a plaque 50 cm in width, 75 cm long and 1.5 cm thick:
a) between 5500 g to 6500 g of calibrated sand;
b) between 200 g to 360 g of silicone; and
c) between 0.4 l to 0.6 l of turpentine.

6. Mass, according to claim 1 wherein the calibrated sand is of the beach kind, the grain being calibrated or of standard size, i.e., between 3 and 0.06 mm by means of a sieve.

7. Mass, according to claim 1, wherein the used silicone is resistant to ultraviolet rays.

8. Process for the preparation of the mass based on calibrated sand and elastic binder, according to claim 1, wherein it includes the following steps:
a) dilution of the silicone with turpentine, using a mechanical mixer, until a homogeneous mixture is obtained;
b) the sand in separate portions, is added, until a homogeneous mixture is obtained with a wet and loosen look;
c) the mixture is introduced in the desired mould to produce the intended shape;
d) the mixture is vibrated through a vibrating table;
e) the mixture is compacted, through tightening by a press or hydraulic system, during the material drying and curing time; and
f) the material takes between 1 to 3 days to reach the desired consistency.
